(19) United States
(12) Patent Application Publication
(10) Pub. No.: US 2015/0234796 A1
(43) Pub. Date: Aug. 20, 2015

(54) CREATING, MANAGING, AND DISTRIBUTING DYNAMIC CONTENT TO SMARTPHONES

(71) Applicant: MOBILE OXYGEN LLC, Boston, MA (US)

(72) Inventors: Jeff E. Williams, Natick, MA (US); Craig Millon, Boston, MA (US)

(21) Appl. No.: 14/624,495

(22) Filed: Feb. 17, 2015

Related U.S. Application Data
(60) Provisional application No. 61/941,155, filed on Feb. 18, 2014.

(51) Int. Cl. G06F 17/22; H04L 29/08; G06F 17/24; H04W 4/02; G06F 17/21; H04W 8/18; H04W 4/18

(52) U.S. Cl. CPC G06F 17/2247; H04W 8/183; H04L 67/02; H04W 4/18; H04W 4/02; G06F 17/211; G06F 17/2288; G06F 17/248

(57) ABSTRACT

Methods, systems, and techniques for communicating with mobile users by providing dynamic content that is relevant to the user's immediate environment by taking environmental context into account such as location, time, weather, and the like are provided. Example embodiments provide an Environment Context-based Mobile Content Management System (“ECMCMS”). The ECMCMS creates a new framework that makes it easier to create, deliver and consume content that is built around the end user's environmental context. The ECMCMS allows for companies, organizations, institutions, and corporations to communicate with their mobile users without requiring established relationships with the providers or distributors of the content. An example ECMCMS comprises a content creation tool, a content conduit, and content production.

### TECHNICAL FIELD

The present disclosure relates to methods, techniques, and systems for generating dynamic content for smartphones and, in particular, to methods, techniques, and systems for generating dynamic content based upon context such as location and delivering content to smartphones via web-based modal windows.

### BACKGROUND

The adoption of multi-touch mobile devices has generated the fastest rate of technology adoption in history. Practically everyone you see these days is clutching their smartphones with a death grip. In just a few short years, mobile adoption has become the world's ‘quiet revolution’ and eclipsed the DVD player as the fastest technology adoption in the history of the world.

The deep adoption of mobile smart devices has created a need for a change in communication models. Previously, communicating via Internet with consumers involved the consumers sitting at a desk or couch and using a point and click system with a computing device. Now, such obstacles as booting up a computer, logging in, and waiting to be connected to the Internet, are no longer a consideration due to the “always on” function of smartphones. This changes the communication model between content creator and content consumer. This “always on” mentality has opened up the need for “micro experiences”—types of communications that mobile users can do “on the go.” Unfortunately, for engaging people on the go without an established relationship, the current communication models don't work well.

Unfortunately, our technology and tools have not caught up to the way modern consumers want their mobile communication delivered. In particular, there is a real problem in the mobile communication cycle that is not being addressed, leading to disjointed and wasteful experiences. We have current products and services that answer the need for initiating contact with consumers (such as mobile search and mobile ads) and for deepening and retaining the relationship (such as mobile websites, apps, and email); however, the mobile experience lacks products and services that “engage” the consumer after an initiated contact without an established relationship and that are adaptive to the consumer's environment. The following products and services are typically available today:

Telemarketing: Calling the end user on the user's mobile phone is the oldest method of reaching end users on their phones. This method has fallen out of favor for most mobile subscribers, who perceive it as invasive, annoying and unwelcome, which has led to regulation by Federal and State Law [Federal Trade Commission, Telephone Consumer Protection Act (TCPA); Controlling the Assault of Non-Solicited Pornography and Marketing (CAN-SPAM) Act]. It is easy and instantaneous but cannot adapt to the user.

Texting: Texting the user, using the phone line to send text/image-based messages facilitated by telecommunication services like Short Message Service (SMS) or Multimedia Message Service (MMS) by permission also provide other ways to communicate with users over mobile networks. Unless a user has given specific consent to receive these messages, the act of texting a user can be illegal Law [Federal Trade Commission, Telephone Consumer Protection Act (TCPA); Controlling the Assault of Non-Solicited Pornography and Marketing (CAN-SPAM) Act]. It is easy and instantaneous but cannot adapt to the user. Moreover, it is often perceived as invasive, intrusive, and unwelcome for establishing a relationship with a potential consumer.

Mobile Applications: “Pushing out” a mobile application for download (or suggesting one for download) that is unique to the user's mobile operating system as a piece of software running on their device provides a way to communicate with mobile consumers to establish and deepen a relationship. It requires specific actions from the user, takes time to set up, and may infringe on a user's privacy with its requested access to user data. It is also is harder and more expensive for the content creator, who cannot create relevant or location-based content that changes constantly very easily within a mobile application framework. It is device-dependent causing a content creator to deploy several versions of the application for every device operating system desired.

Providing a Mobile Optimized Website or Web Page: Formatting and developing HTML content for a mobile Web browser and driving the end user to a Uniform Resource Locator (URL) where they can view the content via a mobile Web provides another way to communicate with mobile consumers to deepen a relationship once established. It is fairly easy and instantaneous but cannot adapt to the user. These websites function more like “online brochures.” Moreover, it is often hard to deliver rich content over a small footprint and to adapt web pages for use with different device requirements. Building them can be expensive and maintaining them a problem due to the constantly changing technology in the Mobile Web space. Frequently, users are left with a Website that has stale content that may be outdated and irrelevant.

“Blue Casting”: Pushing out radio or electronic signals such as Bluetooth, RFID, Near Field Communication (NFC) and other proprietary transmissions, based on an opt in relationship or on-the-spot permission, that acts a conduit from content creator to mobile consumer provides another type of communication with a mobile user. It is cumbersome on many different levels. Firstly, it may be costly to the content creator to install hardware, usually transmitters of some kind, everywhere they want to send the signal. Secondly, a consumer must “enable” the communication by allowing sensors on their phone to be open, such as the Bluetooth receiver. Thirdly, an unsolicited message coming from a Bluetooth alert or other contactless signal source can be perceived as invasive and unwelcome.

Four of these five current technologies (except search) are most useful after a relationship is established with a consumer, but not in the act of establishing them in the first place.

### BRIEF DESCRIPTION OF THE DRAWINGS

The patent or application file contains at least one drawing executed in color. Copies of this patent or patent application publication with color drawings will be provided by the Office upon request and payment of any necessary fee.

FIG. 1 is a block diagram of an example embodiment of an Environment Context-based Mobile Content Management System.

FIG. 2 is a block diagram illustrating the building, distributing, and rendering of environmental based content from the end user to the screen of a smartphone.

FIG. 3 is a flow diagram of an overview of logic for creating, managing, and delivering dynamic content via an example Environment Context-based Mobile Content Management System.

FIGS. 4A-4F are example screen displays of example content dynamically created, managed, and distributed by an example Environment Context-based Mobile Content Management System.

FIG. 5 is a block diagram of an example master template layout provided by an example content creation tool of an example Environment Context-based Mobile Content Management System.

FIGS. 6A-6E are example screen displays for creating a new template for building dynamic content using an example content creation tool of an example Environment Context-based Mobile Content Management System.

FIG. 7 is an example of a distributed tag for embedding in a web page of a content producer.

FIGS. 8A-8C are example screen displays for modifying a template for building dynamic content using an example content creation tool of an example Environment Context-based Mobile Content Management System.

FIG. 9 is an example block diagram of an example computing system that may be used to practice embodiments of a Environment Context-based Mobile Content Management System.

### DETAILED DESCRIPTION

This smartphone phenomenon has created a new paradigm of communication from content creator to content consumer. In particular, for the first time in history, communication based on “context awareness”, such as constantly changing environmental variables like time, location, weather, etc., has become possible on a mainstream scale. There exists a need for a tool that allows content creators to communicate with their end users in a way that allows for time and location to build more relevant content presentation in a way that is easy for the content creator and requires no extra work or privacy issues for the end user.

In order for a content creator to effectively engage a mobile consumer having no established relationship, the following criteria needs to be met:

INSTANTANEOUS. The consumer must not have to do anything for the communication to work.

HYPER RELEVANT. The consumer's context, such as location, time, and other environmental variables, becomes part of the communication.

EASY TO USE SYSTEM. A system or platform that allows content creators to easily manage content and consumers to fluidly use content is employed.

Once engaged in such a manner, the consumer is more likely to graduate into other services that extent the relationship with the content provider such as loyalty services, customer relationship management (CRM) lists, and mobile application adoption. Thus, a mobile communication provided in this fashion improves the customer experience and increases conversions by consumers. This type of communication is referred to as “micro engagement”—it occurs before a user has established a relationship with the content creator but after the user has landed on a web page, for example as a result of a search command. For more information on the doctrine of micro-engagement, see http://digitalincognita.com/2014/01/06/the-doctrine-of-micro-engagement.

The methods, systems, and techniques described herein relate to the creation, management, and distribution of context-based content to modern smartphone or other similar mobile device such that a user can be engaged “on the go” before a relationship has been established with the user. Context herein refers to environmental variables relating to the mobile device and/or environment and are not things that one would think of as user preferences that require knowledge of the particular user. For example, context based upon location, time, weather, keywords, accelerometer values, barometer values, magnetometer values, gyroscope values, camera, light sensors, heat sensors, proximity sensors, speakers, and microphones provide examples of objects and environmental aspects relating to the smartphone that can provide context variable values for use with the techniques described herein.

As used herein, a smartphone is a mobile phone transported by a user. It is is a cellular phone (can send and receive phone calls) that performs many of the functions of a computer, typically having Internet access, and an operating system capable of running downloaded applications. It may also have a touchscreen interface and other features.

Embodiments described herein provide enhanced computer- and network-based methods, techniques, and systems for communicating with users by providing dynamic content (created on-the-fly) that is relevant to the user's immediate environment by taking environmental context into account such as location, time, weather, and the like. Example embodiments provide an Environment Context-based Mobile Content Management System (“ECMCMS”), which enables content creators (or other producers and/or distributors of content) to form “on-the-go” relevant communications with users (potential consumers) to engage them in a manner suitable to the mobile world. The ECMCMS creates a new framework that makes it easier to create, deliver and consume content that is built around the end user's context, such as location, time, and other relevant environmental variables. Ultimately, the ECMCMS allows for companies, organizations, institutions, and corporations to communicate with their mobile users in a new and more effective ways without requiring established relationships with the providers or distributors of the content.

Example embodiments of an ECMCMS create dynamic content, typically, server-side, taking into account environmental variable values collected by the smartphone, and deliver the content onto a designated web page of the content producer using a special type of web page component, known as a modal window overlay (“mobile layer”), without causing the user to leave the web page the user has navigated to. Modal windows can have the appearance of sliding in and out over the web page the user is currently viewing and can be easily dismissed by clicking, for example, on a close button. As designed to operate, the ECMCMS provides a content creation tool for the content producers that allows a content creator to define dynamic content that will appear according to a set of rules that govern the time and location of when and where the content will be delivered. The predefined content such as messaging, logos, images, etc. is stored, typically server-side, and is used to build the dynamic content when the ECMCSM detects that evaluation of a corresponding rule so dictates. In some embodiments, the content creation tool provides a set of predesigned master templates for creating content instance templates (using object-oriented terminology, the content instances are created when an actual instance is created and the data is filled in to be delivered to the smartphone): for example, smart offers for driving foot traffic, daily chalkboards for driving interest, mobile bucks for driving “buzz,” video messages for surprise, photo streams for fun, and special passes for driving attendance. Other master templates are contemplated and easily integrated into the ECMCMS system. In addition, content producers (such as administrators) can define their own enterprise specific master templates based upon environmental variable value rules.

In one example embodiment, the web pages for which these modal windows appear are designated by the content producer embedding an ECMCMS supplied script (e.g., an HTML tag containing Javascript) in the web page content. When the embedded tag is executed (rendered on the client device by the web browser) the invoked script causes the client side (phone) to supply the environmental variable values (the context) to the ECMCMS. The ECMCMS determine which content to build based upon the values of the environmental variables such as location and time, builds the content using previously stored values supplied by the content producer (e.g., the images and text) and related to the environmental variable values, and supplies that content to the client device. The client device (the user's web browser) then renders the dynamically created content as a web modal window. Web modal windows can be created, for example, using capabilities of HTML5 (HyperText Markup Language version 5.0) and CSS3 (Cascading Style Sheets 3.0).

Thus, the ECMCMS creates a fully capable content management system for delivering relevant “on-the-go” content that can driver further user engagement. ECMCMS delivered content feels like a mobile application in its relevance, but it runs across the mobile Web using the user's internet browser.

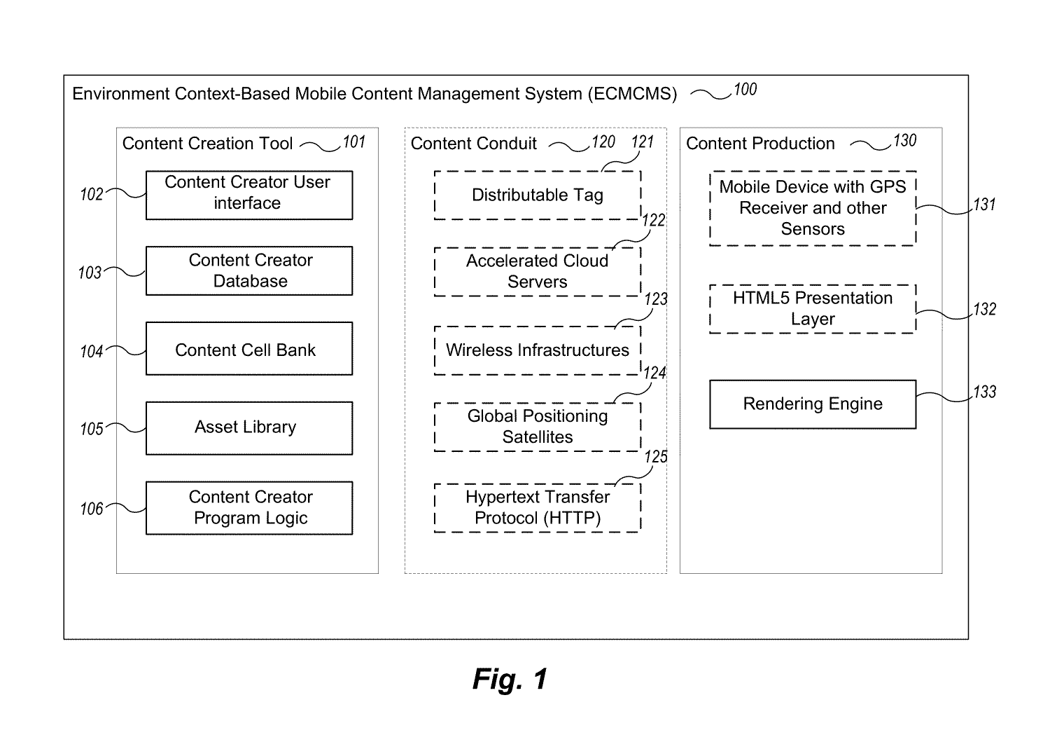

FIG. 1 is a block diagram of an example embodiment of an Environment Context-based Mobile Content Management System. In one example embodiment, the ECMCMS comprises one or more functional components/modules that work together to render environmental context based content on-the-fly on a smartphone. For example, a Environment Context-based Mobile Content Management System 100 may comprise a content creation tool 101, a content conduit 120, and content production 130.

An example content creation tool 101 comprises a content creator user interface (UI) 102, a content creator database 103, a content cell bank 104, a content asset library 105, and a content creator program logic 106. Other and or different components can be incorporated.

In one example embodiment, the content creator UI 102 is a Web-based tool that allows the content creator to create and manage their account, input account details, create and manage specific content instance templates, create rules that govern the content instance templates, launch content instance templates, track metrics and performance on content interaction, and manage the account.

In one example embodiment, the content creator database 103 is a Relational Database Management System (RDBMS) that holds the values authored by the content producer and their specific content instance templates, as well as system and program values related to the content producers (content creators). An authorized content producer can set up an account, create content instance templates, track activity, and manage their content instance templates through the manipulation of the values held in the database. Within the database 103, there exists a special area called the Content Cell Bank. Within this bank, an infinite number of “content cells” exist that are associated with the content producer. These cells hold the values that populate and govern each content instance when it is instantiated. These values are a mix of text, images, media, and conditional logic expressions, that, when the script embedded in the tag is invoked by end user's browser, are used to dynamically build the modal overlay window on the mobile device. The asset library 105 contains an loadable repository of assets, such as images, logos, files, guides, and artwork that can be used to more efficiently create content with specific standards, for example within guidelines of a particular company or enterprise.

The content creator program logic 106 is the programming and rules that govern the content creation process. In one embodiment (attached to the database 103) It has stored objects and stored procedures that are activated when needed, such as tiers of approvals for a multi-user capability, creating a new content instance template, creating a new location cell, previewing content instance templates, editing a content instance template, generating the distributable tag, and/or managing content assets. Other behaviors can be easily incorporated.

The content conduit 120 comprises a distributable tag 121, accelerated cloud server 122, wireless infrastructures 123, Global Positioning Satellites (GPSes) 124, and Hypertext Transfer Protocol (HTTP) 125. The content conduit is used by the ECMCMS 100 yet typically provide by other third parties and thus is shown in dashed lines.

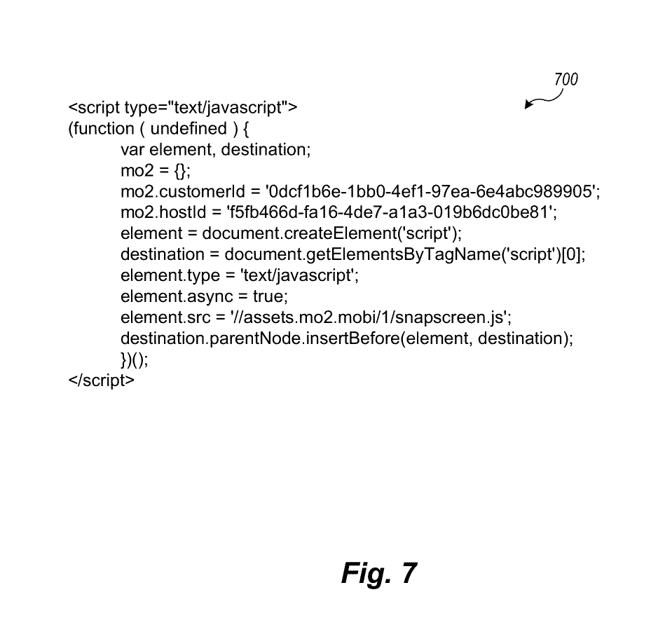

When a content producer wishes to launch a content instance template for instantiating content instances on-the-go, a “distributable tag” 121 must be generated. This tag can be sent to the content producer ahead of time or generated by and obtained from the content creation tool 101. Distributable tag 121 is pasted on a HTTP web page, such as a company's home page, but is can be inserted onto as many pages as desired where modal web windows are to be displayed. Coding aspects of the distributable tag 121 are described below with reference to FIG. 7. The distributable tag 121 contains a unique token identifier that will automatically initiate the layer rendering process to show the dynamic content on the current web page.

All of the assets, scripts, markup language, and data that is part of the content to be dynamically created and rendered lives on an accelerated server-hosting platform 122. This arrangement is beneficial for the content producer because it avoids the producer having to manage any physical files. Using the hosting platform 122, the ECMCMS 100 can provide its services using a Software as a Service (“SaaS”) platform or model. The arrangement is also beneficial for the consumer, since the ECMCMS 100 will render the content to mobile device faster than regular servers.

The data that is transferred from the web server to the end user device uses a variety of telecommunications and Internet infrastructures (wireless infrastructures 123) based on the user's device, carrier, Wi-Fi availability, and location. The advances in wireless and cellular networks, such as 4G LTE have yielded valid and reliable channels for rich content distribution.

GPS units 124 managed by the US Dept. of Defense and the FCC are used by the ECMCMS 100 to calculate and pinpoint the end user device's latitude, longitude and altitude from anywhere in the world. GPS receivers have continued to evolve. GPS systems have become an essential and expected function in every smartphone on the market.

Content dynamically created by the ECMCMS 100 is delivered to the end user smartphones via HTTP (The “Web”) which is standardized and managed by the World Wide Web Consortium (WWW3), which is an open source standard that anyone in the world can use.

The Content Production 130 component comprises the mobile device 131, a presentation layer 132, the rendering script 133 and a rendering engine 134. Several of these subcomponents are provide by others and thus is shown in dashed lines. For example, the mobile device with a GPS receiver 131 is the consumer (or end-user's) smartphone which device runs a mobile computing platform, such as Android, iOS, Windows/Nokia, Blackberry, or other mobile computing operating systems. These devices have GPS receivers embedded by default into their design. The ECMCMS 100 is not dependent on any particular device or operating system, hence it can be referred to as “cross-platform” or “platform-agnostic”. To be ECMCMS enabled, the device 131 is a modern smartphone that supports a mobile web browser.

The HTML5 Presentation Layer 132 an integral part of the user's web browser application that supports rendering the dynamically created content instances. It provides the container that holds the code necessary to display the content instance within a Web Modal Overlay (also called a Web Modal Window) on the user's currently viewed web page. The latest standards for web browsers include a bundle of functionality within the 5th generation of HTML (HTML5). These functions are becoming the de facto standard across the Web and especially for mobile Web. In particular, HTML5 supports multi-touch interfaces better with gesture navigation, more animation effects, synchronous data loading, smoother video performance and more connections to native features of modern smartphones.

The rendering engine 133 resides in the ECMCMS 100 and is invoked by the user's mobile browser rendering the distributable tag 121 embedded in a web page. Thereupon, a series of code objects and procedures respond by causing the most relevant content instance to be instantiated based upon the environmental variable values collected by the smartphone and rendering the appropriate content instance into a web modal window of the user's current web page.

Although the techniques of an ECMCMS are generally applicable to any type of mobile device, they are particularly relevant to mobile devices in which the user desires different content depending upon the user's environmental context (the “on-the-go” nature of phones, for example). In addition, the techniques described herein can be used for other types of mobile devices other than smartphones that desire such environmentally contextual content. Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement an Environment Context-based Mobile Content Management System to be used for creating and managing environmental context based dynamic content. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic, different logic, etc. Thus, the scope of the techniques and/or functions described are not limited by the particular order, selection, or decomposition of aspects described with reference to any particular routine, module, component, and the like.

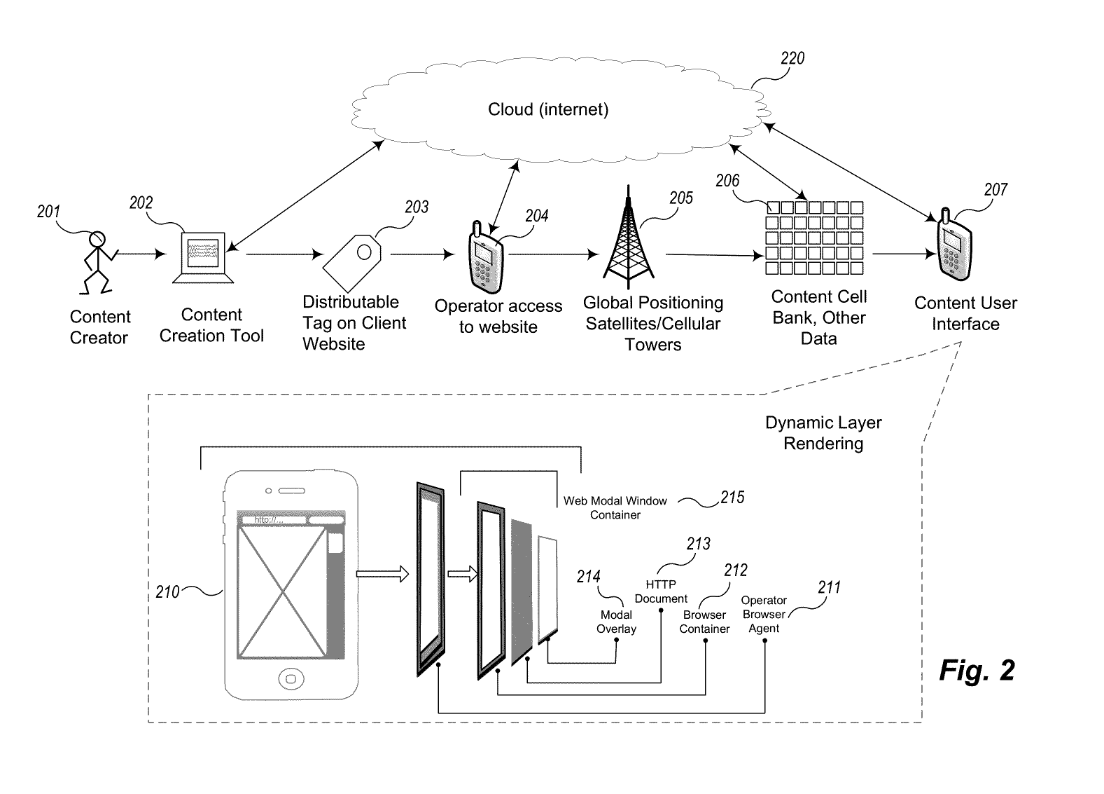

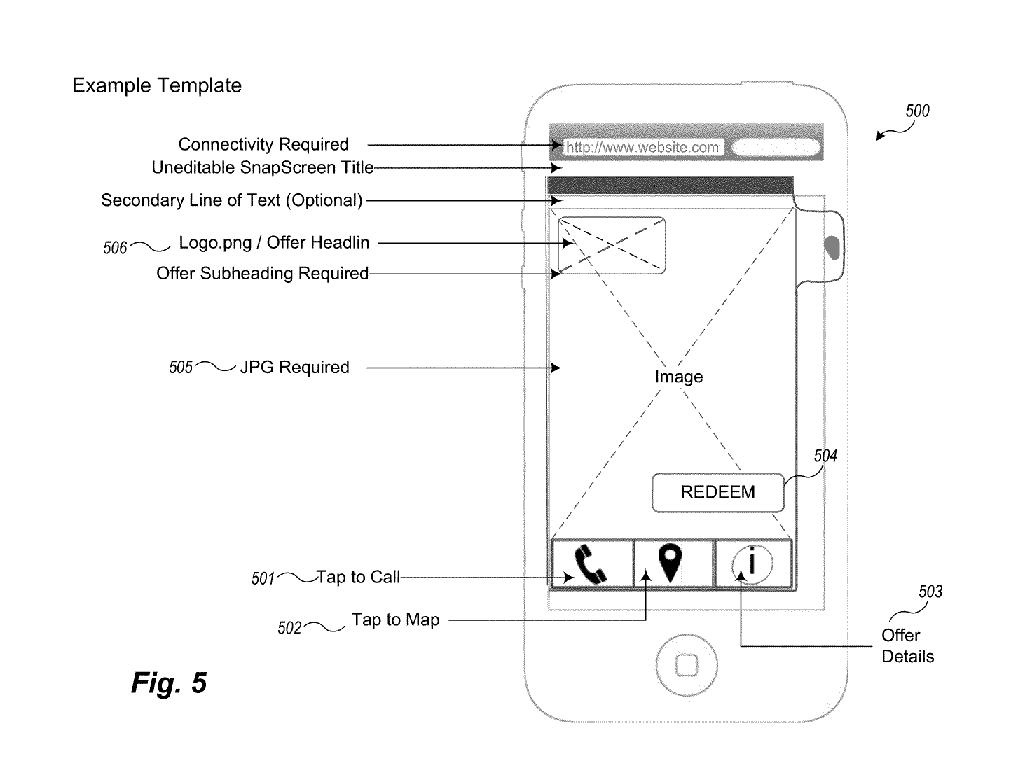

FIG. 2 is a block diagram illustrating the relationship of the components of the Environment Context-based Mobile Content Management System in context and how the dynamic content is rendered on a screen of a smartphone. Content flows through the ECMCMS starting with the content creator (producer) and ending with being rendered on the end user's device. The content creator 201 (the content producer logs into the content creation tool 202 and builds a content instance template (non shown). The content instance template is governed in design and functionality by the master template that is chosen. These are described below with reference to FIGS. 5, 6A-6E, and 8A-8C. Master templates have a variety of purposes and can customized to the industry or segment of the content creator by creating content instance templates. For instance, the content creator may work as a marketing manager for a line of restaurants. She might choose a master template and customize it as a content instance template with certain rules around time and location that meets her business goals. For example, certain types of content may be more relevant to geographic sections of their audiences, or more relevant to the time of day, or the type of weather, etc.

Once the content creator 201 has created and tested the content instance template(s), all the content and logic is stored on a cloud server system 220. As part of the creation of the content instance template, the ECMCMS generates a distributable tag 203. (The tag 203 can also be obtained by other mechanisms such as copying the text string, email, etc.) The content creator 201 can then use the distributable tag 203, for example generated by the content creator program logic 106 of FIG. 1, and insert (embed) the tag 203 into a web page of the client website where she wants the content instance to appear. Note, the content instance itself calls the ECMCMS files, so the code that appears on the client's web page can be completely separate from the web page that hosts it. This allows the hosting web page to be in a format completely independent from the content instance—for example, it may be rendered in a desktop format or a mobile format. In this way, the content instance is platform independent—it will automatically adjust to each mobile device independent of the format of the web page it actually “lives on” by virtue of the embedded tag 203. The content creator 201 can insert the distributable tag 203 on as many web pages as desired and can even do this ahead of using the content creation tool 202 to create the content instance templates if the tag has already been made available to her. Moreover, the content creator 201 can run different content instances on the same page, or can run the same content instance on different pages, or any combination that meets her communication goals. Each distributable tag 203 identifies the content “owner” (producer, creator, website, or the like) and a hosting id on the ECMCMS where the content can be found.

When an end user's device 204 visits the tagged web page of, the device 207 will determine location (latitude and longitude) of the mobile device calculating the precise location, for example, using GPS 205 and other positioning aids such as cellular tower signals 205. These and other environmental variable values are presented to the content instance logic, which responds with the appropriate content from the content cell bank 206 that holds the appropriate data as determined by the content creation tool 202. The content is built on the fly (dynamically) and displays in the browser (user interface) of the end user's smartphone 207 rendered as a web modal window, an overlay on the current web page.

More specifically, as illustrated in 210-215, the web modal window appears as a layer over the current web page and displays the content instance as the content creator intended as expressed in the corresponding content instance template. This web modal window is self-contained and supplied by the ECMCMS server. It is NOT ever seen within the web page of the website if one were to examine, for example, the Document Object Model (DOM) of that web page or its hosting website. The ECMCMS generated web modal window is rendered over the web page of the content producer; hence all content, interaction, UI controls and code processing within the content instance lives in this layer above and is independent from the content producer's web page (and the web site).

Thus, the rendering on the mobile device is composed of the operator browser agent 211, which holds the browser container 212. Within the browser container 212, a live HTTP document (e.g., web page) 213 is displayed. And within the web page 213, a modal overlay 214 “floats above” (overlays) the page with an open and close button. The end user then interacts with the content accordingly. For instance, the user might map a store, browse a list of events near them, redeem an offer, retrieve a pass code, view a video, etc. The end user can dismiss the layer 214 at anytime and summon it again when needed as long as the layer is active on that web page as determined by the content creator. There is no account to sign into, app to download, SMS message to read, link to tap—it just appears on the page and can be dismissed in a single click. In addition, features such as a particularized scan code can be added to the overlay—without any assistance or knowledge from the underlying web page—to enable the end user to redeem something at a point of sale by using an appropriate scanning device.

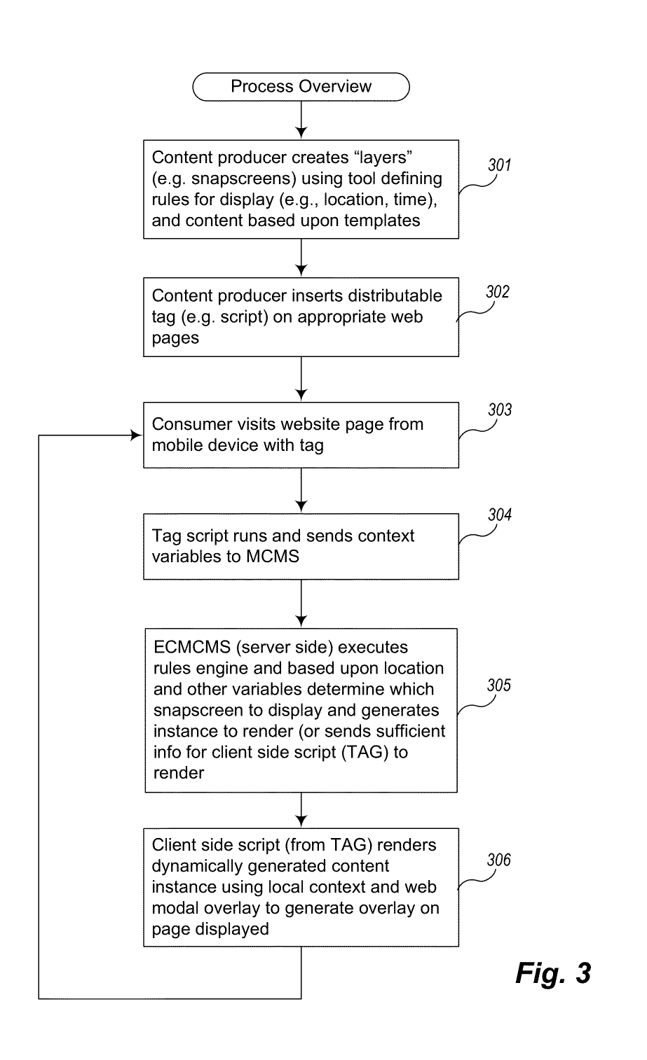

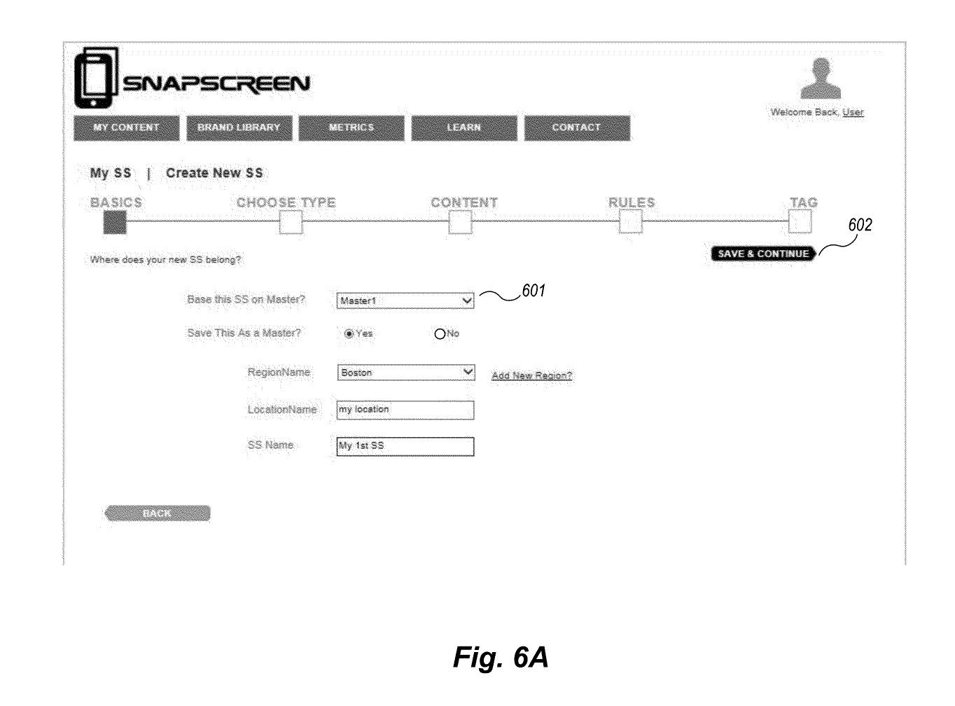

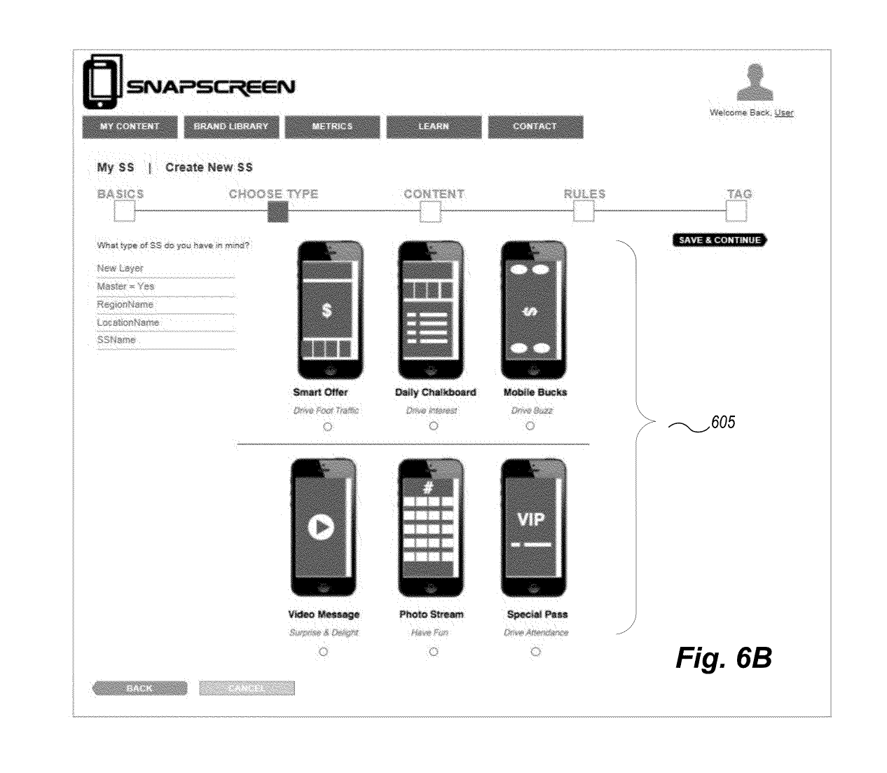

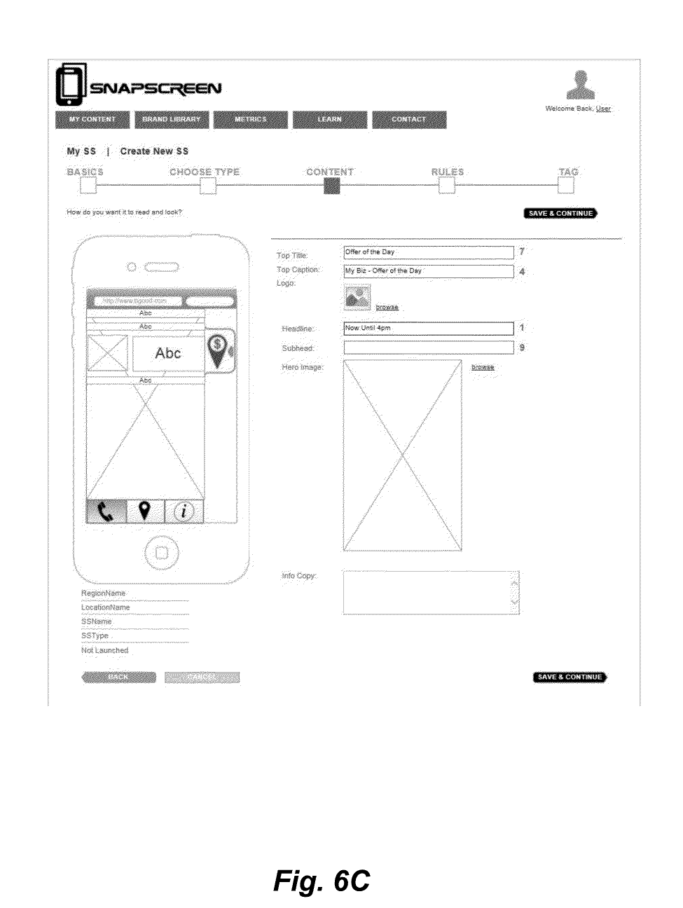

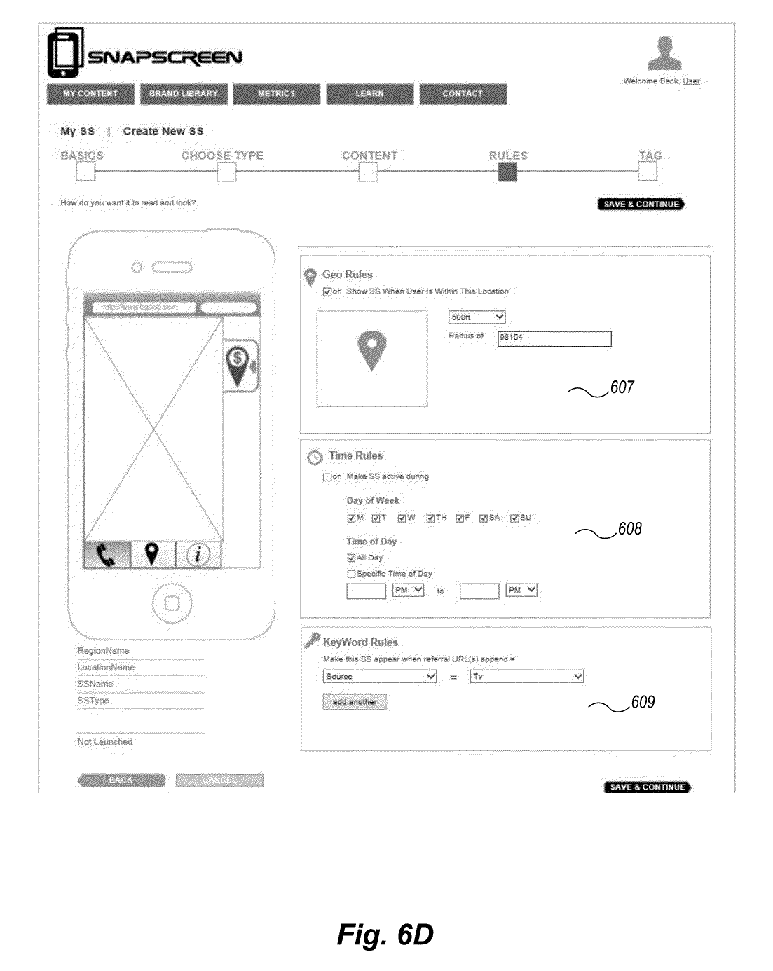

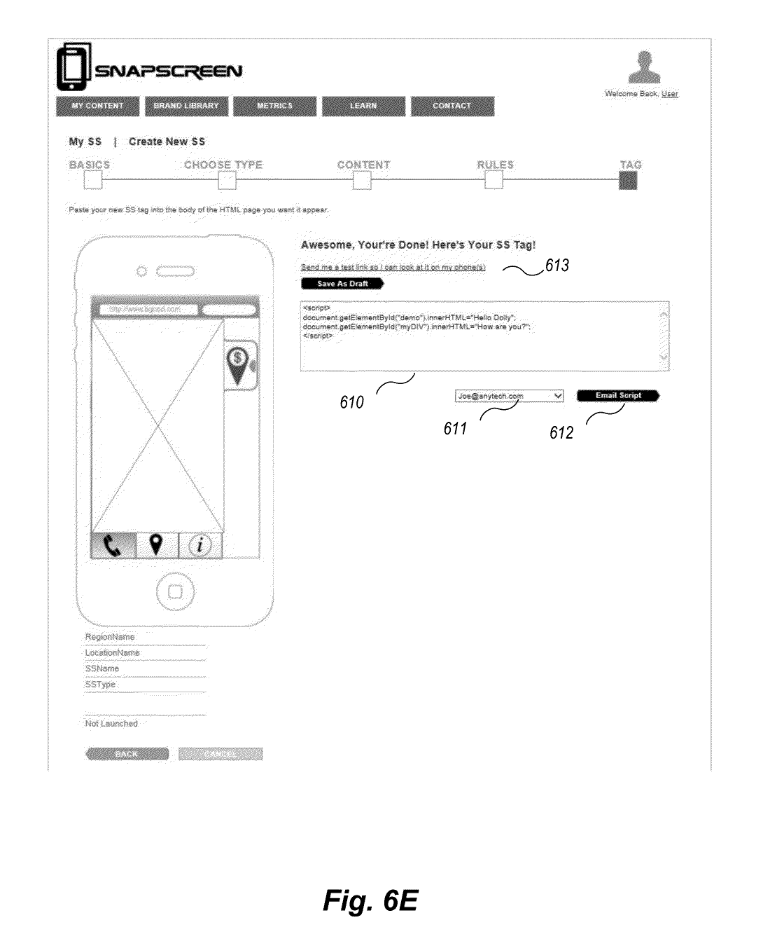

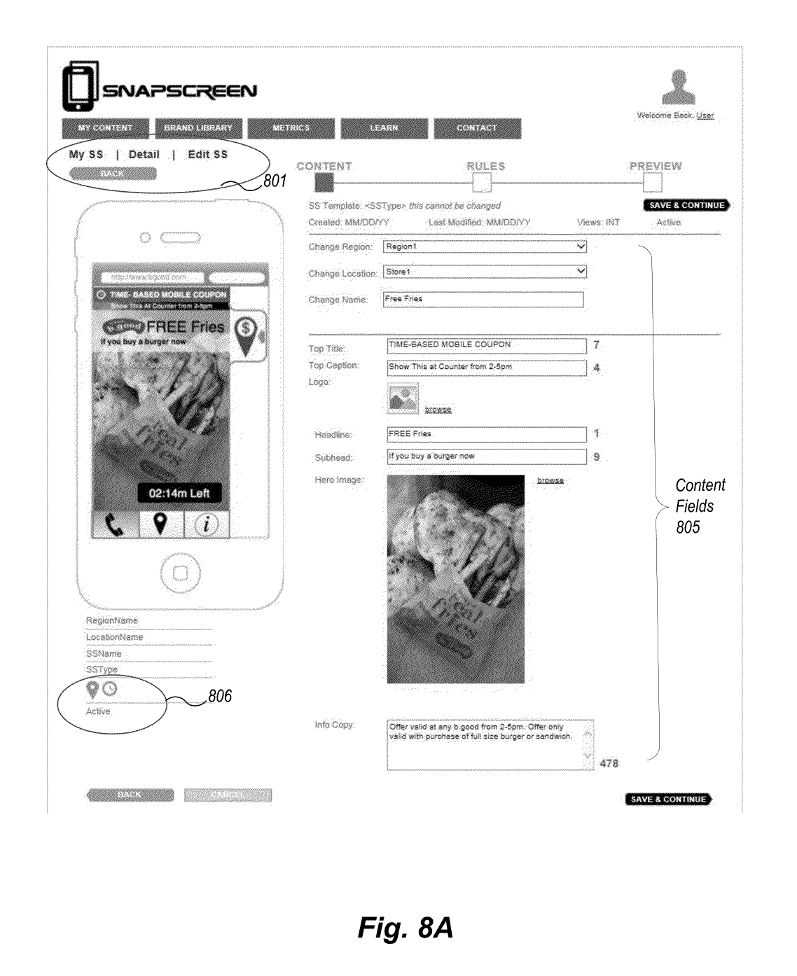

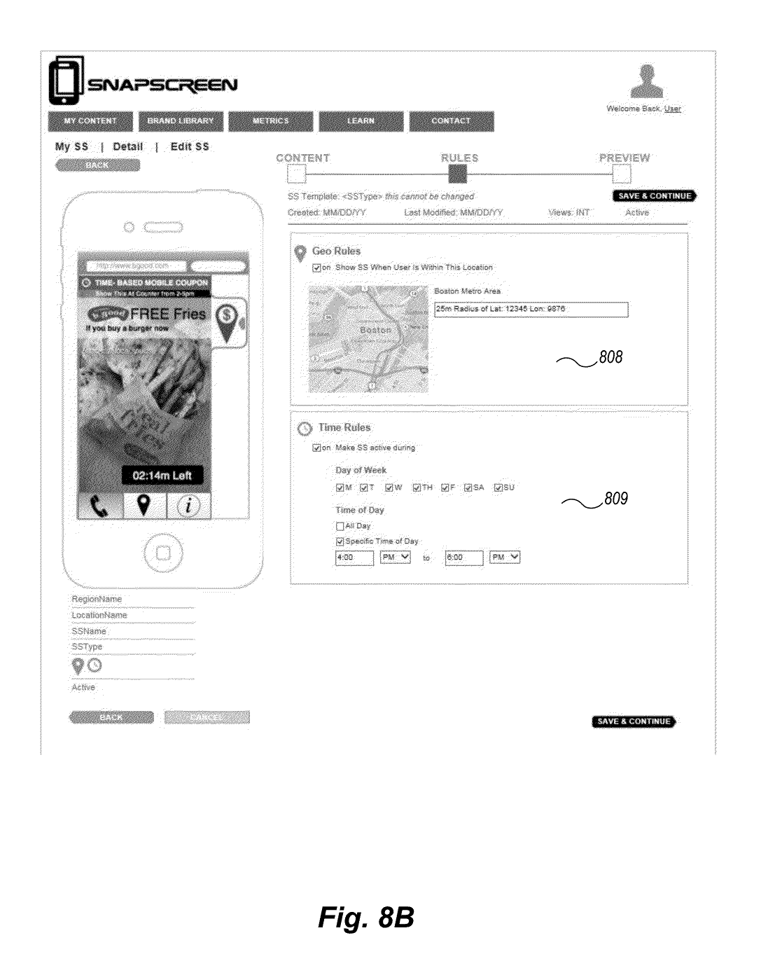

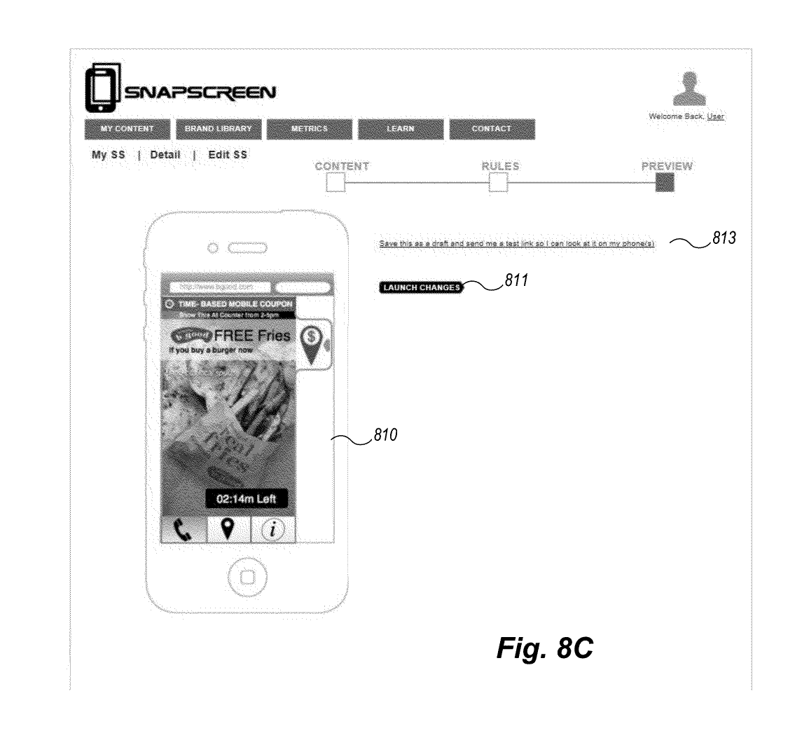

FIG. 3 is a flow diagram of an overview of logic, a method, for creating, managing, and delivering dynamic content via an example Environment Context-based Mobile Content Management System. In block 301, the content creator (content producer) creates “layers” or “mobile layers” (which are overlays called Snapscreens in the content creation tool demonstrated in FIGS. 6A-6E and 8A-8C) using the content creation tool of the ECMCMS. The Snapscreens are associated with rules for their display such as location and time values and define content for display according to templates. In block 302, the content producer inserts one or more distributable tags onto the web page(s) where it is desired to render the dynamic content instances. In block 303, an end user, for example, a consumer visits a “tagged” web page on a website. In block 304, the tag script runs, invokes a ECMCMS script to generate the dynamic content instance using the sensed values of the device (e.g., location through a GPS or equivalent, weather through a barometer, time through a clock, or the like). Then, in block 305, the ECMCMS (server side, typically) executes the various stored objects and procedures or other logic to determine which rules are triggered and thus which (one or more) content instance template(s) to use. IThe appropriate content instance is then generated using data stored with the ECMCMS and the environmental variable values. In block 306, the client side script renders the dynamically created content instance in a web modal window.

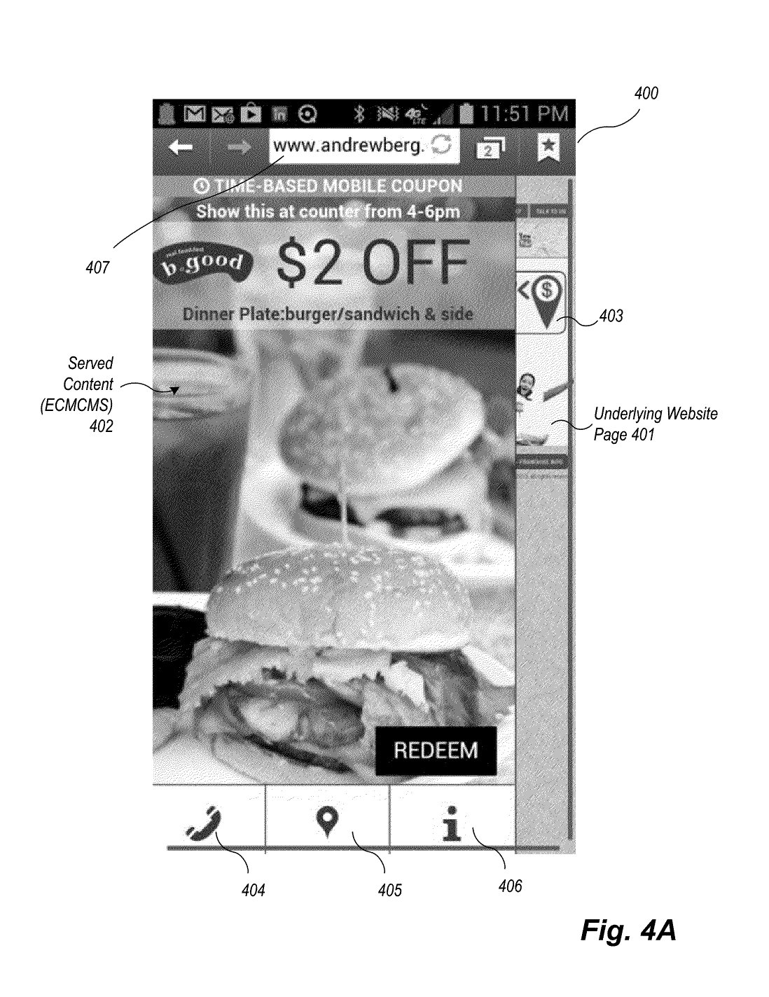

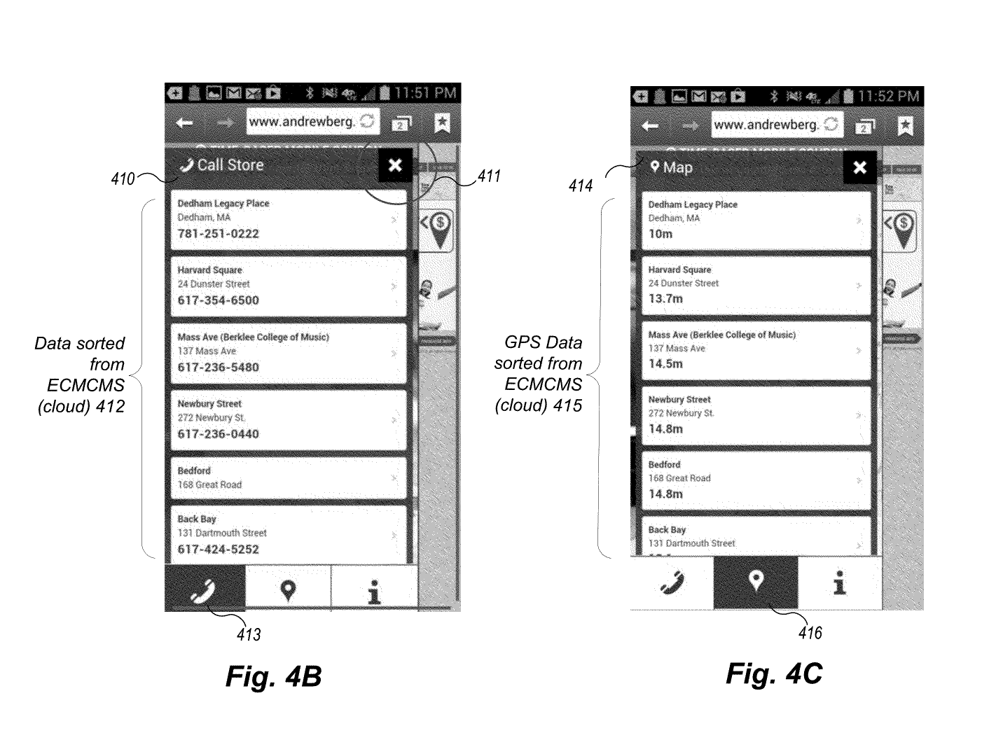

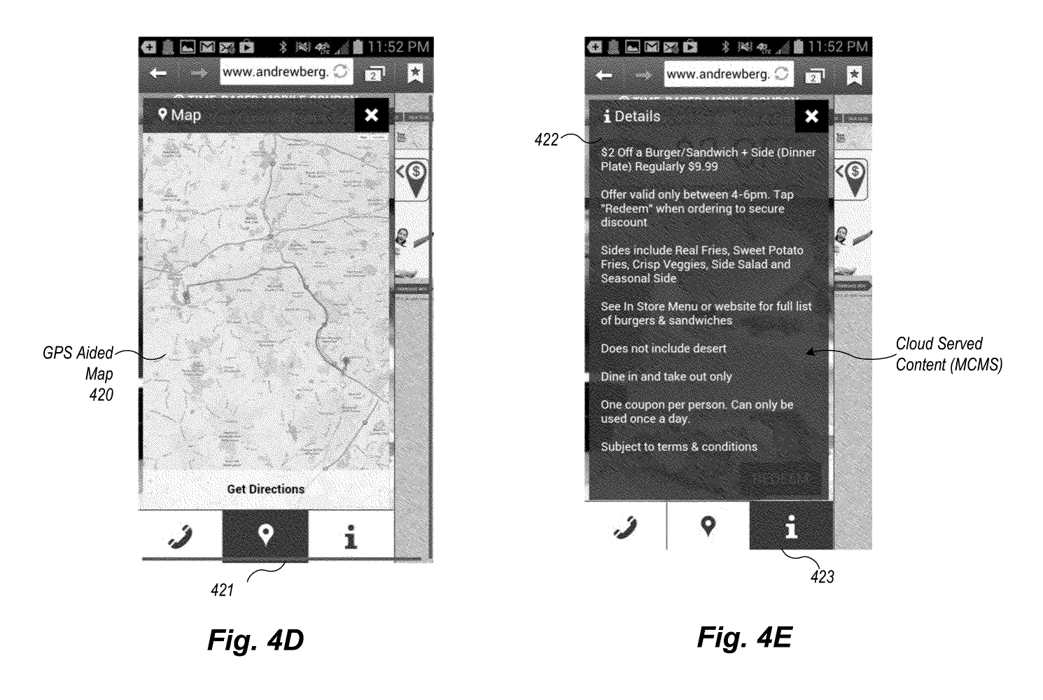

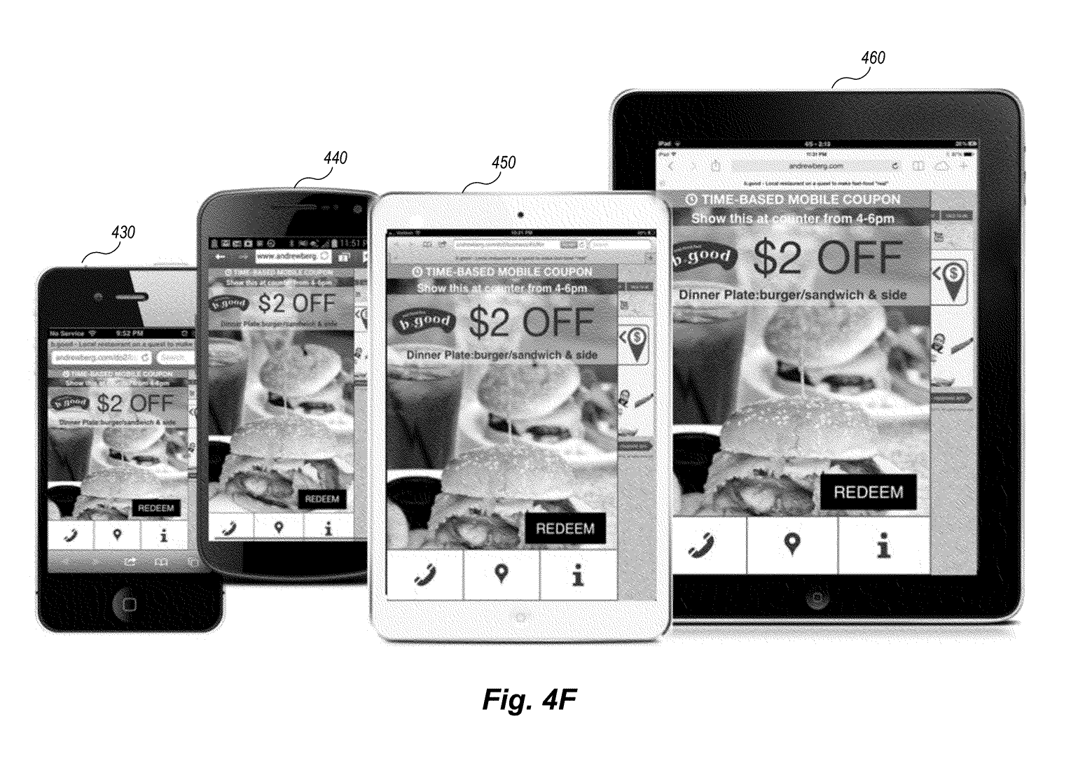

FIGS. 4A-4F are example screen displays of example content dynamically created, managed, and distributed by an example Environment Context-based Mobile Content Management System.

In FIG. 4A, screen display 400 is shown currently rendered by a browser application on a smartphone. As described earlier, once the tag on a web page is rendered, it invokes the ECMCMS to instantiate the appropriate content instance. This content instance is than rendered by the client browser in a web modal window. Content instance 402 is shown rendered when the user navigates to the URL shown in browser history window 407. The underlying website web page 401 shows through beneath the layer that is created and displayed as an overlay 402. The tab 403 can be used to expand and collapse the web modal window. UI control (button) 404 is selectable to invoke an additional content with possible locales related to the content shown in content instance 402. UI control (button) 405 is selectable to show map (e.g. GPS) related information. UI control (button) 406 is selectable to show further detailed information relating to the offer, coupon, or other content displayed in content instance 402. Other UI controls can be similarly incorporated.

FIG. 4B illustrates the resulting content when the user has selected the call control 405 in content instance 402 in FIG. 4A. Here, the content instance 402 shows that the user has selected the call store content 410 via call button 413. The phone numbers for the various locales where the offer shown in FIG. 4A is current are shown in list 412. This content can be generated by considering the user's current and end locations using, for example, a variety of open source mapping APIs, and then filtering them tp show limited information including the phone numbers. In the upper right corner of the content instance, a selectable close control 411 is shown. The user can choose to close the phone number content in a “single click” interface.

FIG. 4C illustrates the resulting content instances when the user has selected the map control 406 in content instance 402 in FIG. 4A to request navigation directions. In response, the ECMCMS can generate maps that consider the end user's current location and the end location using, for example, a variety of open source mapping API's. These mapping results are displayed within the content instance 402. Here, the content instance shows that the user has selected the map information 414 via map button 416. In the upper right corner of the content, a selectable close control is again available. The addresses for the various locales where the offer shown in FIG. 4A is currently available are shown in list 415. The user can select an address to render a GPS aided map 420. Here again, a selectable close control is available.

In FIG. 4E, detailed information for the content shown in the content instance 402 in FIG. 4A is displayed as a resulted of the user selecting selectable information UI control 423. This content is generated and served from the ECMCMS as well. Other types of content that are and are not dependent on GPS related data or upon other environmental variable values may be displayed as desired or dictated by the content instance template.

A content instance can be rendered in different devices and difference screen sizes without any additional work by the content producer. FIG. 4F illustrates the responsive design properties of a content instance. In a typical smartphone 439, the content is fit for the exact screen size. In a larger format smartphone 440, the image takes up more of the screen due to the larger screen space. In a mini tablet 450 format, the content instance displays larger type, larger image and larger controls, but is exactly constrained by the screen size. Even in a large format tablet 460 the content instance appears flawlessly to fill up the screen, scaling up text/image and navigation.

FIG. 5 is a block diagram of an example template layout (a master template) provided by an example content creation tool of an example Environment Context-based Mobile Content Management System. The example template can be used to formulate a content instance template with values specific to the content producer. For example, the text and image values have placeholder containers within the template layout that may be based on the business or industry needs of the content producer. For example, an image appropriate to the offer may be placed in image field 505 and a logo specific to the establishment in logo field 506. In template layout 500, only certain fields are editable, such as the titles, offer headlines, and subheadings, etc. and certain fields such as the tap to call button 501, tap to map button 502, offer details 503, and “redeem” button 504 are not editable. The redeem button 504 may be used by the end user to redeem the offer/coupon etc. at a point of sale. In some scenarios, the establishment may be able to scan information directly from the smartphone, eliminating any need for the user to enter information at all.

Providing certain UI controls in certain places enables the content creators to keep the content instances consistent regardless of who enters or programs the details. Of course many other layouts and possible master templates could be used.

FIGS. 6A-6E are example screen displays for creating a new template for building dynamic content using an example content creation tool of an example Environment Context-based Mobile Content Management System. FIG. 6A shows an example interface for creating a new content instance template. According to this embodiment of the content creation tool, a content instance template is referred to as a “Snapscreen.” In field 601, the content producer/creator can define which template layout (master template) is to be used to create this content instance template. If a new master is to be created this is also possible. The producer can indicate where the content instance template is valid—for example in a particular region in the country, city, address etc. It is up to the content producer (hence the enterprise) to establish the granularity and rules for where a particular content instance template is current and valid.

When the producer selects the “save & continue” UI control 602, then FIG. 6B is displayed. If the producer had not yet selected a master template, then the producer can do so in the interface displayed in FIG. 6B. The different templates are shown as selectable controls 605. Currently, the content creation tool shows six types of master templates: smart offers, daily chalkboard, mobile bucks, video message, photo stream, or special pass as examples. Others or different master templates can be similarly incorporated. Once the producer has selected a template (the producer selects “save & continue”), the tool continues with the display of FIG. 6C.

In FIG. 6C, the producer can enter values into the various fields that are editable, such as the various captions, headline, subheading, image, and logo. When the content entry is complete (the producer selects “save & continue”), then in FIG. 6D the producer is prompted to enter the various “rules” associated with generating and rendering a content instance. In particular, the rules take into account one or more of the environmental variable values the will be “computed” or “sensed” on-the-fly in order to make the content instance timely and relevant. For example, field 607 enables the producer to enter rules based upon location data. Field 608 enables the producer to enter rules based upon time, such as day of week and time of day. Filed 609 enables the producer to enter rules based upon detection of certain keywords in the URL of the referring (the underlying) web page. Other rules can similarly be incorporated such as those addressing weather, altitude, heat, light, etc. Once the producer has finished entering the rules (the producer selects “save & continue”), the tool continues with the display of FIG. 6E.

In FIG. 6E, the tool produces a distributable tag 610 that the content producer can insert into the web pages where she desires to display a content instance. The producer can also have the tag emailed to address 611 by selecting control 612. In addition, a test link 613 can be emailed in order for the producer to preview an instantiated content instance.

FIG. 7 is an example of a distributable tag for embedding in a web page of a content producer. Distributable tag 700 is illustrating containing a script to be rendered client side (by a client web browser or equivalent web application that renders URLs). This script contains an indication of the producer (the enterprise customer) “mo2.customerid” and an indication of where the hosted data is stored on the ECMCMS “mo2.hostid.” In addition, the script contains an indication (a URL) to more javascript code for generating and rendering a content instance as a mobile layer (a Snapscreen) (“//assets.mo2.mobi/1/snapscreen.js’). This code will gather the values for the various environmental variables and cause the appropriate stored object and stored procedures to be executed by the ECMCMS to generate and render a content instance appropriate at that moment.

FIGS. 8A-8C are example screen displays for modifying a template for building dynamic content using an example content creation tool of an example Environment Context-based Mobile Content Management System. In FIG. 8A, the content producer (here a content editor) can edit a currently selected content instance template (a Snapscreen) using selector 801. The content instance template is previewed on the left and the current (editable) values of the various fields are shown in content fields 805. Icons 806 show that both geo and time based rules are active for this content instance template. In addition, not shown, a single content instance template can be active or inactive. Once the content editor is satisfied, she can select “save & continue” to progress to the rules editing screen.

In FIG. 8B, the content editor can modify the various rules, for example, in the geo based rules field 808 or the time based rules field 809. Again, once the content editor is satisfied, she can select “save & continue” to progress to—preview her edits. In FIG. 8C, a preview of the revised content instance is shown as preview instance 810. The user can then choose to activate (launch) the changed instance template using UI control 811 and/or can email a test link 813 to preview an instantiated content instance.

A very similar procedure can be used to edit a master template. UI control 811 is replaced by a control that indicates to save the (edited) master.

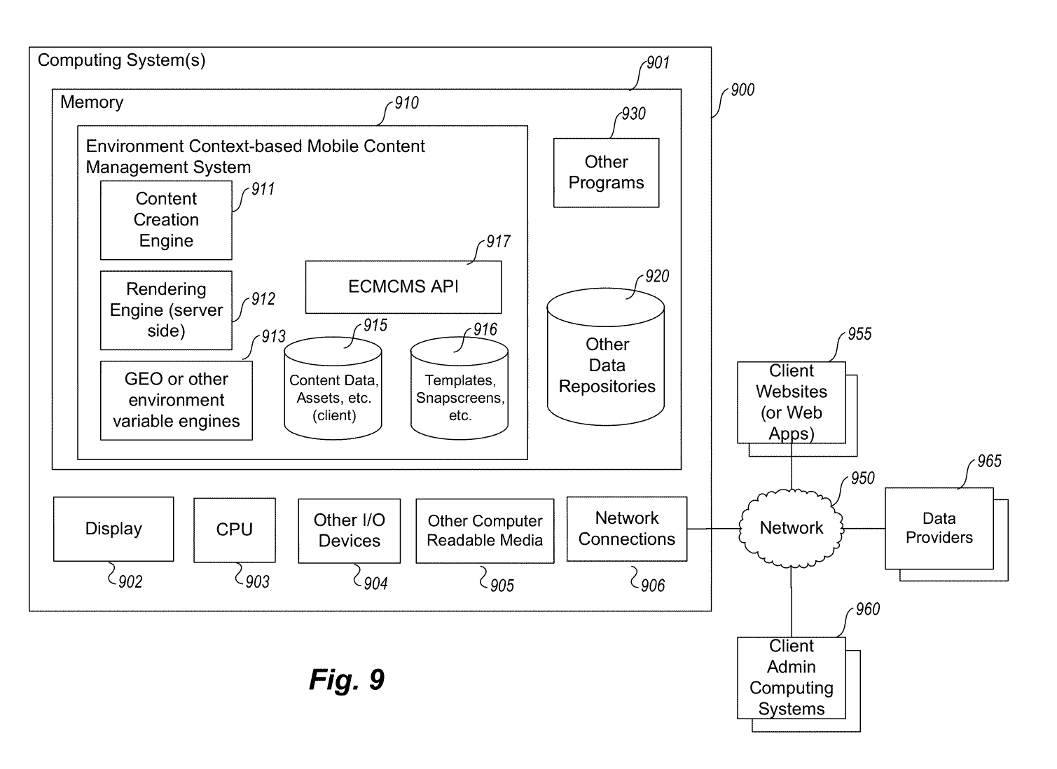

FIG. 9 is an example block diagram of an example computing system that may be used to practice embodiments of a Environment Context-based Mobile Content Management System (“ECMCMS”) described herein. Note that one or more general purpose virtual or physical computing systems suitably instructed to become a special purpose computing system, or a special purpose computing system, may be used to implement an ECMCMS. Further, the ECMCMS may be implemented in software, hardware, firmware, or in some combination to achieve the capabilities described herein.

The computing system 900 may comprise one or more server and/or client computing systems and may span distributed locations. In addition, each block shown may represent one or more such blocks as appropriate to a specific embodiment or may be combined with other blocks. Moreover, the various blocks of the Environment Context-based Mobile Content Management System 910 may physically reside on one or more machines, which use standard (e.g., TCP/IP) or proprietary interprocess communication mechanisms to communicate with each other.

In the embodiment shown, computer system 900 comprises a computer memory (“memory”) 901, a display 902, one or more Central Processing Units (“CPU”) 903, Input/Output devices 904 (e.g., keyboard, mouse, CRT or LCD display, etc.), other computer-readable media 905, and one or more network connections 906. The ECMCMS 910 is shown residing in memory 901. In other embodiments, some portion of the contents, some of, or all of the components of the ECMCMS 910 may be stored on and/or transmitted over the other computer-readable media 905. The components of the Environment Context-based Mobile Content Management System 910 preferably execute on one or more CPUs 903 and manage the generation, storage and use of content instances and templates, as described herein. Other code or programs 930 and potentially other data repositories, such as data repository 906, also reside in the memory 901, and preferably execute on one or more CPUs 903. Of note, one or more of the components in FIG. 9 may not be present in any specific implementation. For example, some embodiments embedded in other software may not provide means for user input or display.

In a typical embodiment, the ECMCMS 910 includes one or more content creation tools or engines 911, rendering logic 912, and one or more interfaces or engines for calculating or determining environment variable based determinations 913, content data, assets or content producers data repository 915, and templates data repository 916. In at least some embodiments, the content creation tools or engines 911, is provided external to the ECMCMS and is available, potentially, over one or more networks 950. Other and/or different modules may be implemented. In addition, the ECMCMS may interact via a network 950 with client (content producer) websites or web applications 955, one or more client (content producer) administrative computing systems 960, and/or one or more third-party information or data provider systems 965, such as purveyors of GPS related information. Also, of note, one or more of the data repositories 915 and/or 916 may be provided external to the ECMCMS as well, for example in a knowledge base accessible over one or more networks 950.

In an example embodiment, components/modules of the ECMCMS 910 are implemented using standard programming techniques. For example, the ECMCMS 910 may be implemented as a “native” executable running on the CPU 103, along with one or more static or dynamic libraries. In other embodiments, the ECMCMS 910 may be implemented as instructions processed by a virtual machine. A range of programming languages known in the art may be employed for implementing such example embodiments, including representative implementations of various programming language paradigms, including but not limited to, object-oriented, functional, procedural, scripting, and declarative.

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported.

In addition, programming interfaces ECMCMS API 917 to the data stored as part of the ECMCMS 910 (e.g., in the data repositories 915 and 916) can be available by standard mechanisms such as through C, C++, C#, and Java APIs; libraries for accessing files, databases, or other data repositories; through scripting languages such as XML; or through Web servers, FTP servers, or other types of servers providing access to stored data. The repositories 915 and 916 may be implemented as one or more database systems, file systems, or any other technique for storing such information, or any combination of the above, including implementations using distributed computing techniques. In addition, the content instances may be implemented as stored procedures, or methods attached to content instance “objects,” although other techniques may be equally effective.

Also the example ECMCMS 910 may be implemented in a distributed environment comprising multiple, even heterogeneous, computer systems and networks. Different configurations and locations of programs and data are contemplated for use with techniques of described herein. In addition, the [server and/or client] may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of an ECMCMS.

Furthermore, in some embodiments, some or all of the components of the ECMCMS 910 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

A typical smartphone has components similar to computing system 900, although not shown. For example, the web browser or client application that renders html pages via HTTP, is stored in a memory and executed by a CPU. There is a display for rendering the web pages and other I/O devices such as a keyboard, and sometimes a pointing device. Network connections, including mobile and/or data network connections, Bluetooth, etc. may also be present. Smartphones also typically provide storage in the form of local memory and other computer readable media.

All of the above U.S. patents, U.S. patent application publications, U.S.

patent applications, foreign patents, foreign patent applications and non-patent publications referred to in this specification and/or listed in the Application Data Sheet, including but not limited to U.S. Provisional Patent Application No. 61/941,155, entitled “METHOD AND SYSTEM FOR CREATING, MANAGING, AND DISTRIBUTING DYNAMIC CONTENT TO SMARTPHONES VIA WEB MODAL WINDOW,” filed Feb. 18, 2014, is incorporated herein by reference, in its entirety.

From the foregoing it will be appreciated that, although specific embodiments have been described herein for purposes of illustration, various modifications may be made without deviating from the spirit and scope of the invention. For example, the methods, systems, and techniques discussed herein are applicable to other architectures. Also, the methods, systems, and techniques discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.) as indicated above.

1. A computer implemented method in a host computing system for generating and distributing content to be rendered on a web page on a client mobile device, comprising:
receiving a request from a web browser of the client mobile device for content associated with an identified content producer and associated with an identified location on the host computing system where the content is stored for the identified content producer;
receiving values for one or more environment variables that indicate a current context sensed by the client mobile device, at least one of the environment variable values including a GPS-based location identifying a current location for the client mobile device, wherein the environment variables are based upon context of the mobile device in the real world and not characteristics of an operator of the mobile device;
determining a stored content instance template associated with the identified content producer and the identified host location, the determined content instance template corresponding to a rule triggered by at least one of the received values for the one or more environment variables, wherein the rule is at least one of location based or time based;
generating a content instance based upon the determined content instance template by including content that is dynamically added to the content instance based upon the received one or more environment variable values; and
causing the client mobile device to render the generated content instance in a separate web modal window on top of the web page rendered by the web browser of the client mobile device, wherein the web modal window provides a self-contained overlay that is not embedded in the web page and does not cause navigation to a new page on the client mobile device.

2. The method of claim 1 wherein the request is received from a script embedded within the web page rendered on the client mobile device.

3. The method of claim 1 wherein the web modal window is provided by a presentation layer of Hypertext Markup Language.

4. The method of claim 1 wherein the generated content instance is automatically sized by the host system to be targeted to the size of the screen of the client mobile device without input from the content producer.

5. The method of claim 1 wherein the content instance is at least one of an offer, a coupon, or guidance based upon a current location of the client mobile device without requiring a user of the mobile device to have any established relationship with the web page.

6. The method of claim 1 wherein the environment variable values include one or more of weather related values, keywords in a URL that causes the web page to be rendered, magnetometer values, barometer values, accelerometer values, light values, heat values, or values that express proximity to an object.

7. The method of claim 1 wherein the content instance is dynamically generated to include at least one image and one logo associated with the content producer.

8. The method of claim 1 wherein the triggered rule is one of a plurality of rules that relate to geographic location, wherein in some geographic locations a first content is to be made available in the generated content instance and in other geographic locations a second content is to be made available in the generated content instance.

9. The method of claim 1 wherein the content instance that is caused to be rendered on the client mobile device can be dismissed by an operator of the mobile client device in a single action.

10. A non-transitory computer-readable memory medium containing instructions for controlling a computer processor in a host computing system to generate and distribute content to be rendered on a web page on a client mobile device, by performing a method comprising:
receiving a request from a web browser of the client mobile device for content associated with an identified content producer and associated with an identified a location on the host computing system where the content is stored for the identified content producer;
receiving values for one or more environment variables that indicate a current context sensed by the client mobile device, at least one of the environment variable values including a GPS-based location identifying a current location for the client mobile device, wherein the environment variables are based upon context of the mobile device in the real world and not characteristics of an operator of the mobile device;
determining a stored content instance template associated with the identified content producer and the identified host location, the determined content instance template corresponding to a rule triggered by at least one of the received values for the one or more environment variables, wherein the rule is at least one of location based or time based;
generating a content instance based upon the determined content instance template by including data that is dynamically added to the content instance based upon the received one or more environment variable values; and
causing the client mobile device to render the generated content instance in a separate web modal window on top of the web page rendered by the web browser of the client mobile device, wherein the web modal window provides a self-contained overlay that is not embedded in the web page and does not cause navigation to a new page on the client mobile device.

11. The memory medium of claim 10 wherein the instructions for generating the content instance are stored in stored procedures associated with the determined stored content instance template.

12. The memory medium of claim 10 wherein the instructions for causing the client mobile device to render the generated content instance in a web modal window within the web page rendered by the web browser are stored in a script that is forwarded to the client mobile device.

13. The memory medium of claim 10 wherein the instructions are executed by a server computing system as part of a service provided to client devices.

13. A host computing system for generating and distributing content to be rendered on a web page on a client mobile device, comprising:
a content distribution engine configured to:
receive a request from a web browser of the client mobile device for content associated with an identified content producer and associated with an identified a host location on the host computing system where the content is stored for the identified content producer;
receive values for one or more environment variables that indicate a current context sensed by the client mobile device, at least one of the environment variable values including a GPS-based location identifying a current location for the client mobile device, wherein the environment variables are based upon context of the mobile device in the real world and not characteristics of an operator of the mobile device;
determine a stored content instance template associated with the identified content producer and the identified host location, the determined content instance template corresponding to a rule triggered by at least one of the received values for the one or more environment variables, wherein the rule is at least one of location based or time based;
generate a content instance based upon the determined content instance template by including content that is dynamically added to the content instance based upon the received one or more environment variable values; and
cause the client mobile device to render the generated content instance in a separate web modal window on top of the web page rendered by the web browser of the client mobile device.

14. The system of claim 13 wherein the content distribution engine is configured to cause the client mobile device to render the generated content instance in a web modal window, wherein the web modal window provides an overlay within a container of the web page within the web browser of the client mobile device and does not cause navigation to a new page on the client mobile device.

15. The system of claim 13 wherein at least one of the received values for at least one of the environment variables is a latitude and longitude sensed by the client mobile device.

16. The system of claim 13 wherein at least one of the received values for at least one of the environment variables is a current time of day computed by the client mobile device.

17. The system of claim 13, the client mobile device having a screen with a size, wherein generated content instance is rendered dynamically for the screen size of the client mobile device.

18. The system of claim 13, further comprising:
a content creation tool configured to:
receive and store information specific to the indentified content producer that is associated with one or more content instance templates; and
identify and store one or more environment context based rules associated with one or more content instance templates.

19. The system of claim 13 wherein the content creation tool is web based.

20. The system of claim 13 wherein the content creation tool is configured to enable the content producer to define the one or more content instance templates based upon geographic location and/or time.
